(19) United States
(12) Patent Application Publication
(10) Pub. No.: US 2017/0225393 A1
(43) Pub. Date: Aug. 10, 2017

(54) APPARATUS AND METHOD FOR FORMING THREE-DIMENSIONAL OBJECTS USING TWO-PHOTON ABSORPTION LINEAR SOLIDIFICATION

(71) Applicant: Global Filtration Systems, a dba of Gulf Filtration Systems Inc., Dearborn Heights, MI (US)

(72) Inventor: Alexandr Shkolnik, Los Angeles, CA (US)

(21) Appl. No.: 15/015,275

(22) Filed: Feb. 4, 2016

(51) Int. Cl. B29C 67/00; B33Y 10/00; B33Y 30/00; B23K 26/342; B23K 26/04; B23K 26/064; B23K 26/067; G02B 26/12; B23K 26/00

(52) U.S. Cl. CPC B29C 67/0066; G02B 26/126; G02B 26/127; B29C 67/0085; B33Y 10/00; B33Y 30/00; B23K 26/0081; B23K 26/04; B23K 26/064; B23K 26/067; B23K 26/342

(57) ABSTRACT

An apparatus and method for making a three-dimensional object from a solidifiable material using two photon absorption is described. The use of two photon absorption allows for the creation of a non-solidification zone beneath the exposed surface of a solidifiable material so that no separation is required between the most recently solidified layer of the object and a substrate such as a glass, a film, or a glass/film combination. In addition, when used with a linear scanning device, two photon absorption causes solidification to occur within a small spot area, which provides a means for creating larger, higher resolution objects than DLP systems or laser systems that use single photon absorption.

### FIELD

The disclosure relates to an apparatus and method for manufacturing three-dimensional objects, and more specifically, to an apparatus and method for using linear solidification and two-photon absorption to form such objects.

### DESCRIPTION OF THE RELATED ART

Three-dimensional rapid prototyping and manufacturing allows for quick and accurate production of components at high accuracy. Machining steps may be reduced or eliminated using such techniques and certain components may be functionally equivalent to their regular production counterparts depending on the materials used for production.

The components produced may range in size from small to large parts. The manufacture of parts may be based on various technologies including photo-polymer hardening using light or laser curing methods. Secondary curing may take place with exposure to, for example, ultraviolet (UV) light. A process to convert a computer aided design (CAD) data to a data model suitable for rapid manufacturing may be used to produce data suitable for constructing the component. Then, a pattern generator may be used to construct the part. An example of a pattern generator may include the use of DLP (Digital Light Processing technology) from Texas Instruments®, SXRD™ (Silicon X-tal Reflective Display), LCD (Liquid Crystal Display), LCOS (Liquid Crystal on Silicon), DMD (digital mirror device), MLA from JVC, SLM (Spatial light modulator) or any type of selective light modulation system.

Many of the foregoing devices are limited in the size of objects that they can make at high resolutions. For example, DMD devices include an array of small mirrors which vibrate to transmit light to a light hardenable solidifiable material. As the objects become bigger, each mirror (and pixel) occupies a larger area of the exposed solidifiable material surface, causing resolution to degrade. Laser based systems that use galvo mirrors typically have resolutions that are limited by the laser energy per unit area.

In most processes that involve the solidification of a photohardenable material, the photoinitiator only absorbs one photon of light at a given moment. This limits the amount of energy absorbed, and consequently, the extent of photopolymerization/cross-linking reactions that are necessary to solidify a photopolymer resin.

Two photon absorption has also been proposed. With two photon absorption, a single electron in a photoinitiator absorbs two photons simultaneously to transcend the energy gap in one excitation event. With two photon absorption, the rate of polymerization scales quadratically with light intensity, whereas with single photon absorption, the rate of polymerization scales linearly. Two photon absorption allows a comparably lower energy to be used to excite photoinitiators and monomers/oligomers/uncured or partially-cured photopolymers. Two photon absorption has a small cross-section and occurs only within the close vicinity of the laser focal point. Thus, by choosing the right combination of photoinitiators, resins, and optics, solidification occurs at small, targeted locations, thereby increasing the resolution of the three-dimensional object. In particular, femtosecond laser irradiation has been found to provide two-photon absorption effects. However, a steep intensity gradient and high intensity are required in order to ensure that two photon absorption occurs at the desired location—and not elsewhere—relative to the exposed surface of the solidifiable material.

Certain two photon systems use lenses to provide the desired gradient and targeted, localized laser light intensity. Generally, a short focal distance lens is required and the lenses tend to be wide. In order to use such systems to create three-dimensional objects by solidifying a solidifiable material, the lenses must be designed and adjusted to create a focal point beneath the exposed solidifiable material surface without causing two photon absorption between the focal point and the exposed solidifiable material surface. However, in such known lens-based systems either the lenses must move relative to the solidifiable material or the solidifiable material must move relative to the lenses. Given the required width of the lenses, moving the lenses is cumbersome and increases the complexity of the apparatus and would slow down the process of making a three-dimensional object. Moving the solidifiable material is often similarly problematic.

Thus, a need has arisen for an apparatus and method that addresses the foregoing issues.

### BRIEF DESCRIPTION OF THE DRAWINGS

The disclosure will now be described, by way of example, with reference to the accompanying drawings, in which:

FIG. 1A is a schematic view of a first example of a system for making a three-dimensional object from a solidifiable material using two photon absorption;

FIG. 1B is a close-up view of FIG. 1A showing a region of non-solidification above a point where the two laser beams intersect;

FIG. 2 is a schematic view of a second example of a system for making a three-dimensional object from a solidifiable material using two photon absorption;

FIG. 3 is a schematic view of a third example of a system for making a three-dimensional object from a solidifiable material using two photon absorption;

FIG. 4 is a schematic view of a fourth example of a system for making a three-dimensional object from a solidifiable material using two photon absorption;

FIG. 5 is a perspective view of the optics of the linear solidification device of FIG. 3;

FIG. 6 is a side elevational view of the optics of the linear solidification device of FIG. 3; and

FIG. 7 is a schematic view of one of the linear solidification devices of FIG. 1 and FIG. 2.

Like numerals refer to like parts in the drawings.

### DETAILED DESCRIPTION

The Figures illustrate examples of an apparatus and method for manufacturing a three-dimensional object from a solidifiable material. Based on the foregoing, it is to be generally understood that the nomenclature used herein is simply for convenience and the terms used to describe the invention should be given the broadest meaning by one of ordinary skill in the art.

The apparatuses and methods described herein are generally applicable to additive manufacturing of three-dimensional objects, such as components or parts (discussed herein generally as objects), but may be used beyond that scope for alternative applications. The system and methods generally include a laser and at least one linear scanning device that applies solidification energy to a solidifiable material, such as a photohardenable resin with a photoinitiator, and optionally, a multiphoton sensitizer. The laser, the at least one linear scanning device, and the solidifiable material are configured such that solidification occurs at a focal point spaced apart from the exposed surface of the solidifiable material along a build (z) axis. Between the focal point and the exposed surface, single photon absorption occurs at an incident energy level that is insufficient to cause the solidifiable material to solidify. Thus, even in those examples in which a glass, film or glass and film substrate is used to planarize the exposed surface, the solidifiable material does not solidify in contact with that substrate, thereby obviating the need to separate the most recently solidified object surface from the substrate. By configuring the system so that solidification only occurs in regions where two photon absorption occurs, the regions of solidification also become much smaller as compared to regions in which single photon absorption is used with a corresponding intensity sufficient to cause solidification. As a result, with two-photon absorption, the resolution of the three-dimensional object increases relative to single photon absorption systems.

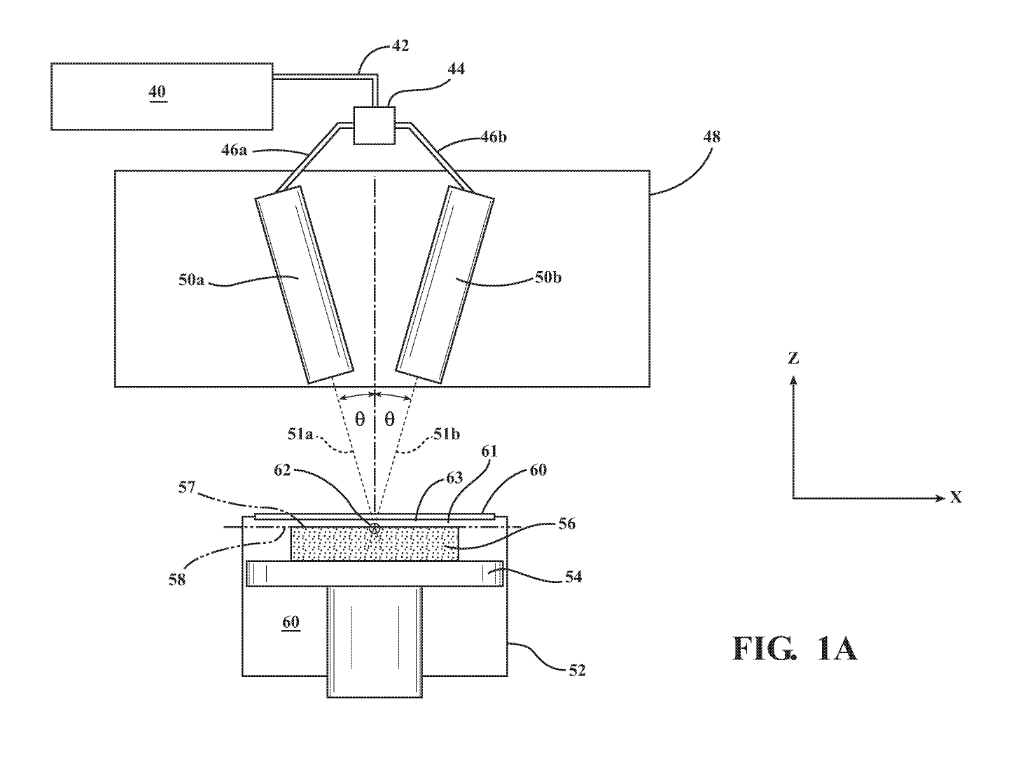

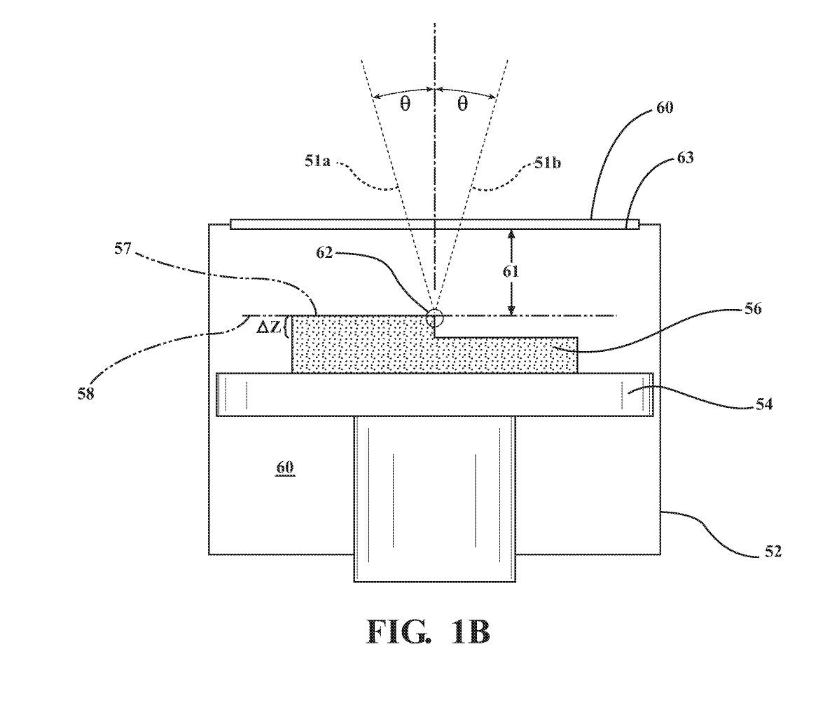

Referring to FIG. 1A, a system for making a three-dimensional object from a solidifiable material 60 using two photon absorption is depicted. Container 52 includes a solidifiable material 60. The solidifiable material 60 preferably comprises a photohardenable liquid or semi-liquid such as monomers, oligomers, or mixtures thereof, and/or partially polymerized monomers, or polymeric resins that are un-crosslinked or only partially crosslinked. As discussed herein, a solidifiable material 60 is a material that when subjected to energy, wholly or partially hardens. This reaction to solidification or partial solidification may be used as the basis for constructing the three-dimensional object. Examples of a solidifiable material 60 may include a polymerizable or cross-linkable material, a photopolymer, a photo powder, a photo paste, or a photosensitive composite that contains any kind of ceramic based powder such as aluminum oxide or zirconium oxide or ytteria stabilized zirconium oxide, a curable silicone composition, silica based nano-particles or nano-composites. The solidifiable material 60 may further include fillers. Moreover, the solidifiable material my take on a final form (e.g., after exposure to the electromagnetic radiation) that may vary from semi-solids, pastes, solids, waxes, and crystalline solids.

When discussing a photopolymerizable, photocurable, or solidifiable material, any material is meant, possibly comprising a resin and optionally further components, which is solidifiable by means of supply of stimulating energy such as electromagnetic radiation, suitably, a material that is polymerizable and/or cross-linkable (i.e., curable) by electromagnetic radiation, including infrared (IR), ultraviolet (UV), and/or visible light. In an example, a material comprising a resin formed from at least one ethylenically unsaturated compound (including but not limited to (meth)acrylate monomers and polymers) and/or at least one epoxy group-containing compound may be used. Suitable other components of the solidifiable material include, for example, inorganic and/or organic fillers, coloring substances, viscose-controlling agents, etc., but are not limited thereto.

The solidifiable material 60 also comprises a photoinitiator. Preferred photoinitiators are those that are capable of being excited to triplet states by absorbing combined two-photon energy. The photoinitiator absorbs light and generates free radicals which start the polymerization and/or crosslinking process. In certain examples, the photoinitiator is selected to have an excitation wavelength that lies within the range of the one-half the laser 40 wavelength range. The two-photons generated in a two photon absorption process will generally have an associated wavelength that is half that of the laser 40 wavelength. Therefore, when using a laser 40 with an infrared wavelength, the photoinitiator will preferably be one that is activated by ultraviolet wavelengths, which are approximately one half of infrared wavelengths.

Suitable types of ultraviolet photoinitiators include metallocenes, 1,2 di-ketones, acylphosphine oxides, benzyldimethyl-ketals, α-amino ketones, and α-hydroxy ketones. Examples of suitable metallocenes include Bis (eta 5-2,4-cyclopenadien-1-yl) Bis [2,6-difluoro-3-(1H-pyrrol-1-yl) phenyl] titanium, such as Irgacure 784, which is supplied by Ciba Specialty chemicals. Examples of suitable 1,2 di-ketones include quinones such as camphorquinone. Examples of suitable acylphosphine oxides include bis acyl phosphine oxide (BAPO), which is supplied under the name Irgacure 819, and mono acyl phosphine oxide (MAPO) which is supplied under the name Darocur® TPO. Both Irgacure 819 and Darocur® TPO are supplied by Ciba Specialty Chemicals. Examples of suitable benzyldimethyl ketals include alpha, alpha-dimethoxy-alpha-phenylacetophenone, which is supplied under the name Irgacure 651. Suitable α-amino ketones include 2-benzyl-2-(dimethylamino)-1-[4-(4-morpholinyl) phenyl]-1-butanone, which is supplied under the name Irgacure 369. Suitable α-hydroxy ketones include 1-hydroxy-cyclohexyl-phenyl-ketone, which is supplied under the name Irgacure 184 and a 50-50 (by weight) mixture of 1-hydroxy-cyclohexyl-phenyl-ketone and benzophenone, which is supplied under the name Irgacure 500.

Referring to FIG. 1A, build platform 54 is movable along the build (z) axis and carries the three-dimensional object 56 which is progressively built in an upward direction along the build (z) axis as the build platform 54 progressively moves downward along the build (z) axis and into the volume of solidifiable material 60 in container 52. A substrate such as a glass 70 or a film is used to planarize the exposed surface 63 of the solidifiable material.

Solidification energy is provided by laser 40. Laser 40 is preferably selected to generate sufficient energy to cause two photon absorption in the photoinitiator(s) in the solidifiable material 60. Light from laser 40 is split in an optical fiber splitter 44 and directed to respective linear scanning devices 50a and 50b which together define a movable assembly 48. The light supplied to each linear scanning device 50a and 50b has about one half the intensity and the same wavelength as the light supplied by laser 40 to optical fiber splitter 44. Linear scanning devices 50a and 50b scan laser light received from corresponding optical fiber splitter outputs 46a and 46b in linear patterns along a scanning (y) axis. The linear scanning devices 50a and 50b are tilted at an angle θ relative to the build (z) axis so that their respective output beams 51a and 51b intersect at a focal point 62. Focal point 62 lies within solidifiable material 60 at a selected distance from exposed resin surface 63 along the build (z) axis. The focal point 62 scans along the scanning (y) axis and travels along the travel (x) axis with movable assembly 48, thereby defining a focal plane 58, which is the location of all possible points of intersection between output beams 51a and 51b in the plane perpendicular to the build (z) axis (i.e., in the x-y plane). In the region between exposed surface 63 of the solidifiable material 60 and focal plane 58, single photon absorption occurs, and the intensity is insufficient to solidify solidifiable material 60. As a result, and as best seen in FIG. 1B, a non-solidification zone 61 is created. The non-solidification zone 61 is a region through which light from output beams 51a and 51b passes but in which no solidification occurs. Thus, the exposed object surface 63 does not solidify in contact with glass 70. As a result, object 56 need not be peeled from glass 70 or otherwise separated from it prior to forming a new object layer, which improves the overall speed of the build process. In the system of FIG. 1A, laser 40 does not travel with the linear scanning devices 50a and 50b. In addition, the beam splitting avoids the need for large lenses and ensures the creation of non-solidification zone 61. Linear scanning devices 50a and 50b contain respective rotating polygonal mirrors that receive laser light and deflect it through respective openings in the bottom of linear scanning devices 50a and 50b which are oriented along the scanning (y) axis. At any one instance when laser 40 is active, output beams 51a and 51b will intersect at a focal point 62. However, when laser 40 is toggled ON, focal point 62 will move along the scanning (y) axis and define a focal line along the scanning (y) axis. As the movable assembly 48 moves along the travel (x) axis, the focal line will define the focal plane 58, as discussed previously.

Suitable lasers 40 are those that can cause the two photon effect to occur, including UV, near IR, and IR lasers. Laser 40 is preferably a pulsed laser, with a pulse width that is preferably less than about 10⁻⁸ seconds, more preferably less than about 10⁻⁹ second, and most preferably less than about 10⁻¹¹ second). Laser pulses in the femtosecond (10¹⁵ second) regime are most preferred.

In one example, laser 40 is a femtosecond laser with a wavelength ranging from about 600 nm to about 800 nm, preferably from about 680 nm to about 760 nm, and more preferably from about 700 nm to about 740 nm. At the focal point 62, two photons are generated with associated wavelengths of about one-half that of the laser 40. When the laser outputs 51a and 51b from linear scanning devices 50a and 50b recombine at focal point 62, the intensity is doubled to match that of the laser 40. Laser 40 also has an average output power that is preferably at least about 150 mW, more preferably at least about 200 mW, even more preferably at least about 500 mW, and still more preferably at least about 600 mW.

Suitable commercially available lasers for use as laser 40 include femtosecond near-infrared titanium sapphire oscillators pumped by an argon-ion laser, for example, a Coherent Mira Optima 900-F pumped by a Coherent Innova. This laser operates at 76 MHz, has a pulse width of less than 200 femtoseconds, is tunable between 700 and 980 nm, and has average power up to 1.4 Watts. Another example is a Spectra Physics “Mai Tai” Ti:sapphire laser system. This laser operates at 80 MHz, has an average power about 0.85 Watts, is tunable from 750 to 850 nm, and has a pulse width of about 100 femtoseconds. A particularly preferred laser is the Octavius Ti:Sapphire 85-M-HP oscillator with an integrated pump laser supplied by Thorlabs, Inc., which has a pulse width of less than 8 femtoseconds and an output power of greater than 600 mW. The pump laser is based on Optically Pumped Semiconductor Laser (OPSL) technology.

One skilled in the art can choose appropriate settings to use such laser systems to carry out multiphoton polymerization. For example, pulse energy per square unit of area (Ep) can vary within a wide range and factors such as pulse duration, intensity, and focus can be adjusted to achieve the desired solidification result in accordance with conventional practices. If Ep is too high, the material being solidified can be ablated or otherwise degraded. If Ep is too low, solidification may not occur or may occur too slowly.

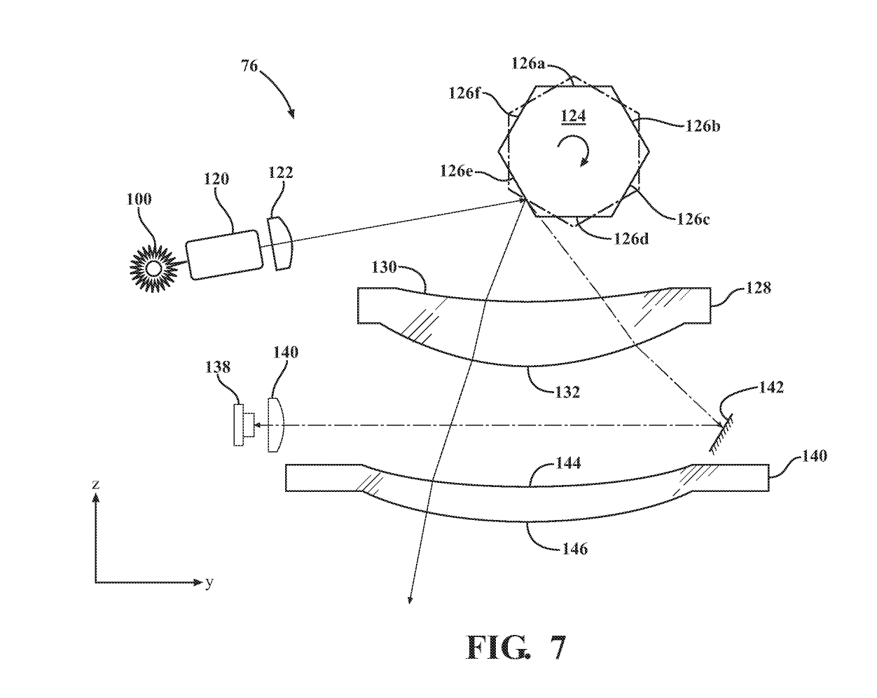

In certain examples, each linear scanning device 50a and 50b is configured as shown in FIG. 7. Each linear scanning device 50a and 50b receives laser light from its corresponding optical fiber splitter output 46a, 46b via an input port 100. As shown in the figure, port 100 (and hence the laser light) is in optical communication with one facet 126(a)-(f) of rotating energy deflector 124 at any one time as rotating energy deflector 124 rotates in the y-z plane (i.e., the plane orthogonal to the travel (x) axis along which the movable assembly 48 moves). In this embodiment, one or more solidification energy focusing devices is provided between input port 100 and rotating energy deflector 124. In the example of FIG. 7, the one or more focusing devices comprises a collimator 120 and a cylindrical lens 122.

Collimator 120 is provided between solidification energy input port 100 and cylindrical lens 122. Cylindrical lens 122 is provided between collimator 120 and rotating energy deflector 124. Collimator 120 is also a focusing lens and creates a round shaped beam. Cylindrical lens 122 stretches the round-shaped beam into a more linear form to allow the beam to decrease the area of impact against rotating energy deflector 124 and more precisely fit the beam within the dimensions of one particular facet 126(a)-(f). Thus, solidification energy received at input port 100 passes through collimator 120 first and cylindrical lens 122 second before reaching a particular facet 126(a)-(f) of rotating energy deflector 124.

In certain preferred examples where laser 40 is a femtosecond laser with a wavelength range between 600 nm and 800 nm, collimator 120 and/or cylindrical lens 122 transmit at least 90%, preferably at least 92%, and more preferably at least 95% of the incident light having a wavelength ranging from about 300 nm to about 400 nm. In one example, collimator 120 and cylindrical lens 122 transmit at least about 95% of the incident light having a wavelength of about 360 nm. Collimator 120 is preferably configured to receive incident laser light having a “butterfly” shape and convert it into a round beam for transmission to cylindrical lens 122.

In certain examples, collimator 120 has an effective focal length that ranges from about 4.0 mm to about 4.1 mm, preferably from about 4.0 mm to about 4.5 mm, and more preferably from about 4.01 mm to about 4.03 mm. In one example, collimator 120 is a molded glass aspheric collimator lens having an effective focal length of about 4.02 mm. One such collimator 120 is a Geltech′ anti-reflective coated, molded glass aspheric collimator lens supplied as part number 671TME-405 by Thorlabs, Inc. of Newton, N.J. This collimator is formed from ECO-550 glass, has an effective focal length of 4.02 mm, and has a numerical aperture of 0.60.

In certain examples, collimator 120 and/or cylindrical lens 122 are optimized based on the specific wavelength and beam divergence characteristics of laser 40. In one example, collimator 120 and/or cylindrical lens 122 are formed from a borosilicate glass such as BK-7 optical glass. In certain preferred examples, collimator 120 and/or cylindrical lens 122 are coated with an anti-reflective coating such that the coated collimator 120 and coated cylindrical lens 122 transmit at least 90%, preferably at least 92%, and more preferably at least 95% of the incident light having a wavelength ranging from about 300 nm to about 400 nm. Suitable anti-reflective coatings include magnesium difluoride (MgF₂) coatings such as the ARSL0001 MgF₂ coating supplied by Siltint Industries of the United Kingdom.

F-Theta lenses 128 and 140 are spaced apart from one another and from the rotating energy deflector 124 along the z-axis direction (i.e., the axis that is perpendicular to the scanning direction and the direction of movement of the linear scanning device 80). First F-Theta lens 128 is positioned between second F-Theta lens 140 and rotating energy deflector 124. Second F-Theta lens 140 is positioned between first F-Theta lens 128 and the solidifiable material 60 (as well as between first F-Theta lens 128 and a light opening in the housing, not shown in FIG. 7).

First F-Theta lens 128 includes an incident face 130 and a transmissive face 132. Incident face 130 receives deflected solidification energy from rotating energy deflector 124. Transmissive face 132 transmits solidification energy from first F-Theta lens 128 to second F-Theta lens 140. Similarly, second F-Theta lens 140 includes incident face 144 and transmissive face 146. Incident face 144 receives solidification energy transmitted from transmissive face 132 of first F-Theta lens 128, and transmissive face 146 transmits solidification energy from second F-Theta lens 140 to a housing light opening (not shown in FIG. 7) and to the solidifiable material.

In certain implementations of the linear solidification device of FIG. 7, first F-Theta lens 128 has a refractive index that is less than that of second F-Theta lens 140. The relative difference in refractive indices helps reduce laser beam scattering losses. At the same time or in other implementations, the radius of curvature of first F-Theta lens transmissive face 132 is less than the radius of curvature of second F-Theta lens transmissive face 146. Suitable pairs of F-Theta lenses are commercially available and include F-Theta lenses supplied by Konica Minolta and HP. In certain embodiments, the F-Theta lenses 128 and 140 are preferably coated with an anti-reflective coating. The anti-reflective coating is used to maximize the amount of selected wavelengths of solidification energy that are transmitted through F-Theta lenses 128 and 140. In one example, the anti-reflective coating allows the coated F-Theta lenses 128 and 140 to transmit greater than 90 percent of the incident solidification energy having a wavelength between about 325 nm and 420 nm, preferably greater than 90 percent of the incident solidification energy having a wavelength between about 380 nm and about 420 nm, more preferably greater than about 92 percent of the incident solidification energy having a wavelength between about 380 nm and about 420 nm, and still more preferably greater than 95 percent of the incident solidification energy having a wavelength between about 380 nm and about 420 nm. In one specific example, the coated F-theta lenses transmit at least about 95% of the incident light having a wavelength of about 405 nm (i.e., blue laser light). In other preferred embodiments, collimator 120, and cylindrical lens 122 are also coated with the same anti-reflective coating. Suitable anti-reflective coatings include magnesium difluoride (MgF2) coatings such as the ARSL001 coating supplied by Siltint Industries of the United Kingdom.

As the rotating energy deflector 124 rotates, laser light will strike one of the facets 126a-126f. The rotation of rotating energy deflector 124 changes the angular orientation of the facet, which causes the deflected energy to travel through first F-theta lens 128 and second F-theta lens 140 and strike the solidifiable material in a linear pattern along the scanning (y) axis. As the next successive facet 126a-126f comes into optical communication with the laser light, a new scan line begins. Details of the operation of the linear scanning devices 50a and 50b are provided in U.S. Pat. No. 9,079,355, the entirety of which is hereby incorporated by reference.

As mentioned previously, many prior art systems use a solidification substrate such as glass 70 to planarize the surface of the solidifiable material. However, in such systems the energy incident to the resin at the solidification substrate is sufficient to cause solidification, and the solidifiable material hardens in contact with the substrate. As a result, a separation step is typically required to separate the newly formed exposed object surface 57 from the solidification substrate. However, examples of the present disclosure allow the distance between the glass 70 (and the exposed solidifiable material surface 63 on which it sits) and the focal point 62 to be set to create a non-solidification zone 61 (FIG. 1B) in which the laser energy is insufficient to cause solidification. In the example of FIGS. 1A and 1B, the linear scanning devices 50a and 50b are tilted away from one another relative to the build (z) axis by a tilt angle θ. The ends of the linear scanning devices 50a/50b, 76a/76b that are closest to the solidifiable material 60 (i.e., the ends with the housing openings through which the laser beams exit) are closer together along the travel (x) axis than are the opposite ends of linear scanning devices 50a/50b and 76a/76b which are connected to the optical fiber beam splitter 42, 73. The tilt angle θ and the x-axis spacing between the bottom of the linear scanning devices (where beams 51a and 51b exit the housings of the linear scanning devices 50a and 50b) determines the point of intersection of beams 51a and 51b, and hence, the location of focal point 62. In preferred examples, the tilt angle θ is equal for both linear scanning devices 50a and 50b. In the same or other examples, the focal point 62 is spaced apart from the glass 70 along the build (z) axis so that no solidifiable material solidifies in contact with glass 70. Preferred build (z) axis distances for non-solidification zone 61 are from about 0.2 mm to about 0.5 mm, and preferably from about 0.3 mm to about 0.4 mm. Preferred values of the tilt angle θ are from about 10 degrees to about 20 degrees, and more preferred values of the tilt angle θ are from about 14 degrees to about 16 degrees. The energy of each individual beam 51a and 51b is sufficient only to cause single photon absorption by the initiators and is insufficient to effect solidification.

The energy input to a given volume of solidifiable material is inversely proportional to the area of the incident laser light. Thus, for a circular laser spot, the incident amount of energy is inversely proportional to the square of the diameter of the spot. Two photon absorption tends to occur in relatively small volumes, which beneficially allows for greater object resolution. Thus, the spot size at focal point 62 is preferably no more than about 20 microns, more preferably no more than about 15 microns, and still more preferably no more than about 10 microns.

The energization state (ON or OFF) of laser 40 is preferably determined by data strings that includes time values at which the laser 40 is toggled on and off. Examples of such data strings are provided in FIGS. 16(d), 16(f), and 16(g) of U.S. Pat. No. 9,079,344. The linear scanning devices 50a and 50b each include a sensor 138 (FIG. 7) which indicates when a line scanning operation is about to begin for that linear scanning device. At a particular angular orientation of each facet 126(a)-126(f), deflected solidification energy will strike mirror 142 and sensor 138. The sensor 138 may be used to reset a timer that dictates when the time values in the data strings have been reached. Neutral density filter 140 (FIG. 7) may also be provided and is described in U.S. Pat. No. 9,079,344.

In order to solidify a line of solidifiable material along the scanning axis, the operation of the linear scanning devices 50a and 50b should be coordinated to ensure that the beams 51a and 51b intersect and are not spaced apart along the scanning (y) axis. It will not necessarily be the case that their respective solidification energy sensors 138 will be triggered at the same time due to differences in the rotation of their respective rotating energy deflectors 124.

Through experimentation, the operation of the motors used to rotate the rotating energy deflectors 124 in each linear scanning device 50a and 50b can be calibrated relative to one another to ensure that the beams 51a and 51b fully intersect. In one example, one of the sensors 138 for one of the linear scanning devices 50a and 50b may be used to toggle the laser 40 on and off. The other sensor 138 may be ignored or used to adjust the rotation of the rotating energy deflector 124 of the other linear scanning device 50a and 50b to ensure that the beams 51a and 51b intersect.

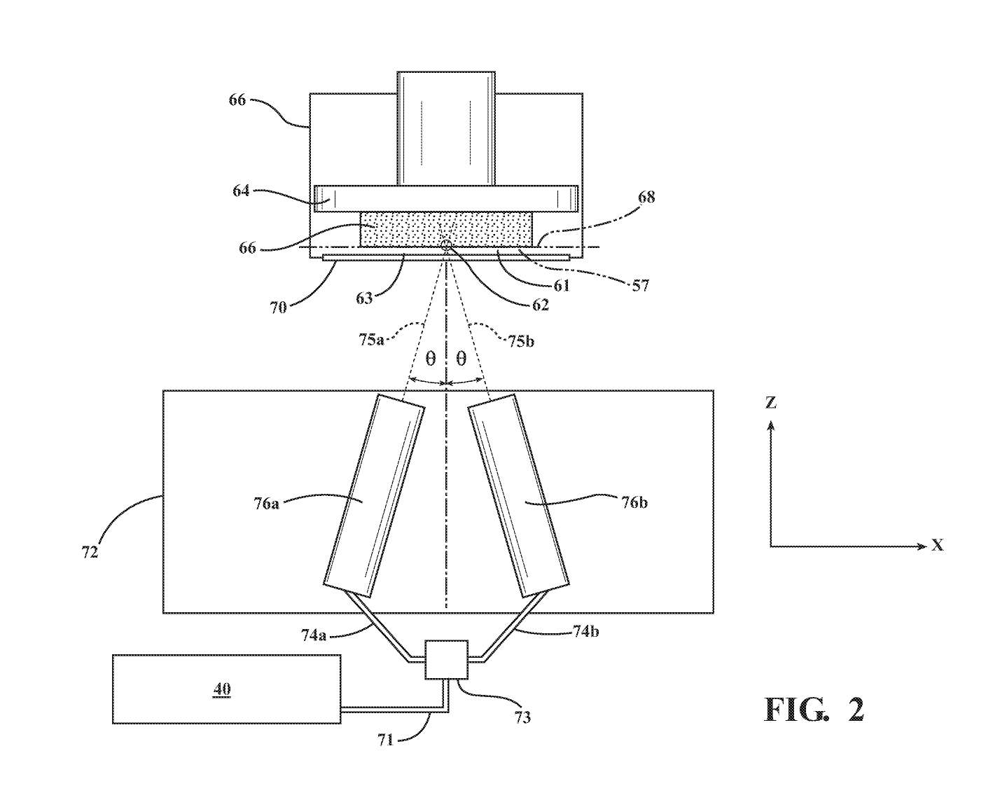

In the example of FIGS. 1A and 1B, the object 56 is built “right-side up” on the build platform 64, and the linear scanning devices 50a and 50b are located above the solidifiable material container 52 along the build axis. However, upside down build processes may also be used. Referring to FIG. 2, solidifable material container 66 is located above linear scanning devices 76a and 76b along the build (z) axis. Object 56 is built “upside down” with a surface adhering to the build platform 54 being positioned above the exposed object surface 57 along the build (z) axis. The bottom of the container 66 is sealed and may be completely or partially formed from a glass panel 70. Alternatively, container 66 may be formed from a transparent polymeric material such as an acrylic or silicone material. As with the example of FIGS. 1A and 1B, linear scanning devices 76a and 76b collectively define a movable assembly 72 that is translatable along the travel (x) axis, but preferably not along the scanning (y) axis or the build (z) axis. Laser 40 is of the type described previously for the example of FIGS. 1A and 1B. The output of laser 40 is split by an optical fiber splitter 73 which provides laser outputs to linear scanning devices 76a and 76b via respective splitter outputs 74a and 74b. The laser light received by linear scanning devices 76a and 76b has a wavelength that is half of the wavelength of the laser light transmitted to the splitter 73 via splitter input 71.

Linear scanning devices 76a and 76b are configured similarly to linear scanning devices 50a and 50b of FIG. 1A except that they are oriented upside down so that the f-theta lenses 128 and 140 are located above the rotating energy deflector 124 along the build (z) axis (upside down relative to FIG. 7). The linear scanning devices 76a, 76b are tilted away from one another relative to the build (z) axis by an angle θ that preferably has the same values as described previously for FIGS. 1A and 1B. As a result, the output laser beams 75a and 75b from linear scanning devices 76a and 76b intersect at a focal point 62 that is spaced apart from the bottom 70 of container 66 and the exposed surface 63 of the solidifiable material 60 that abuts the bottom 70. Between the exposed surface 63 and the focal point 62, single photon absorption occurs, and the laser energy is insufficient to cause the solidifiable material 60 to solidify. At the focal point 62, two photon absorption occurs, which provides sufficient energy to cause solidification. As a result, a non-solidification zone like non-solidification zone 61 in FIG. 1B is created between the exposed surface 63 of the solidifiable material and the focal point 62. Thus, the exposed object surface 57 does not solidify in contact with the glass 70, avoiding the need for a means to separate the object 56 from the glass 70.

During a solidification operation, the laser beams 75a and 75b are scanned along the scanning (y) axis as the movable assembly 72 travels along the travel (x) axis. The focal point 62 also scans along the scanning (y) axis. The two dimensional movement of the focal point 62 defines a focal plane 68 which is the plane that defines the locations at which linear scanning device output beams 75a and 75b may intersect. The operation of the rotating polygonal mirrors 124 in each linear scanning device 76a and 76b is preferably coordinated to ensure that the linear scanning device 76a and 76b output beams 75a and 75b intersect and are not spaced apart along the scanning (y) axis. Object data, such as data strings described previously, is used to toggle the energization state of laser 40 between ON and OFF.

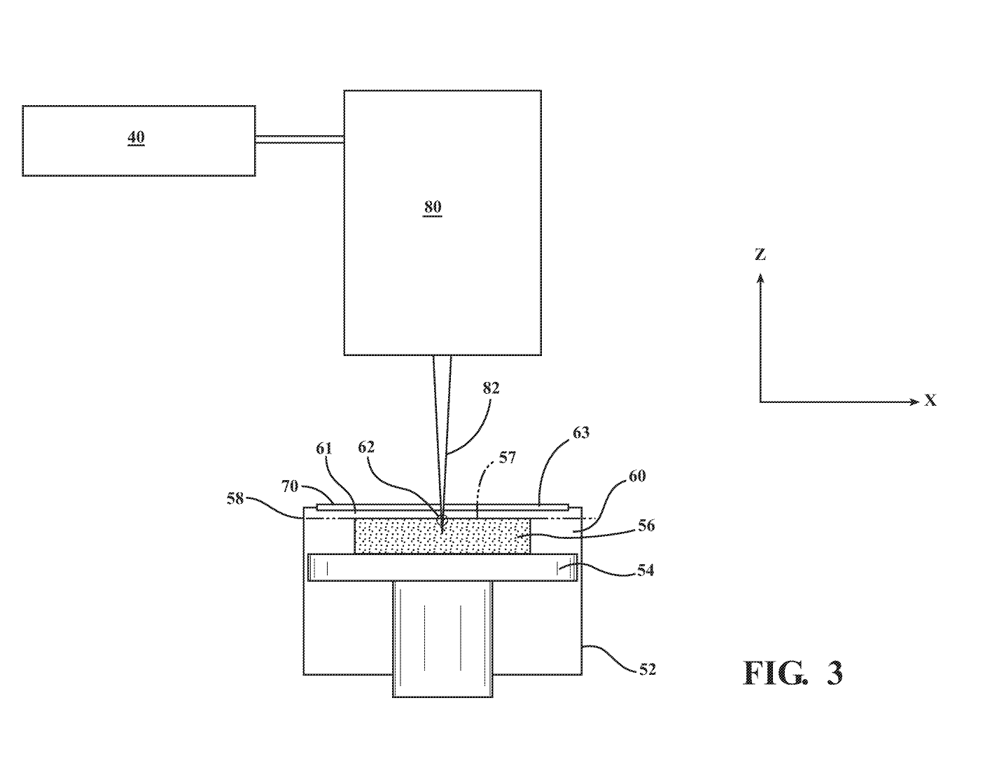

The example of FIG. 3 also depicts a system for making a three-dimensional object from a solidifiable material using two photon absorption. The system includes laser 40, which is of the type described previously, and a single linear scanning device 80. Unlike the examples of FIGS. 1A-B and 2, the example of FIG. 3 does not use an optical fiber beam splitter and does not recombine split beams at a focal point spaced apart from the exposed surface of the resin. Instead, the system of FIG. 3 includes focusing optics that control the depth of the focal point 62 so that no solidification occurs between the exposed resin surface 63 and the focal point 62, thereby creating a non-solidification zone 61 as shown in FIG. 1B. In the non-solidification zone 61, the solidification energy is not concentrated enough to provide the intensity necessary to cause two photon absorption. Only single photon absorption occurs, and the laser energy is insufficient with single photon absorption to cause solidification. An example of a suitable linear scanning device 80 is described in U.S. Patent Application Publication No. 2014/0009811, the entirety of which is hereby incorporated by reference. In one example in accordance with the foregoing, the shape of the first and second mirror is optimized for telecentricity less than 5 degrees and line bow less than +20/−20 microns for mechanical scan angles of +/−16 degrees, and a spot size variation less than 5%. In the Example of FIG. 3, laser 40 may be stationary or it may travel concurrently and in tandem with linear scanning device 80 along the travel (x) axis.

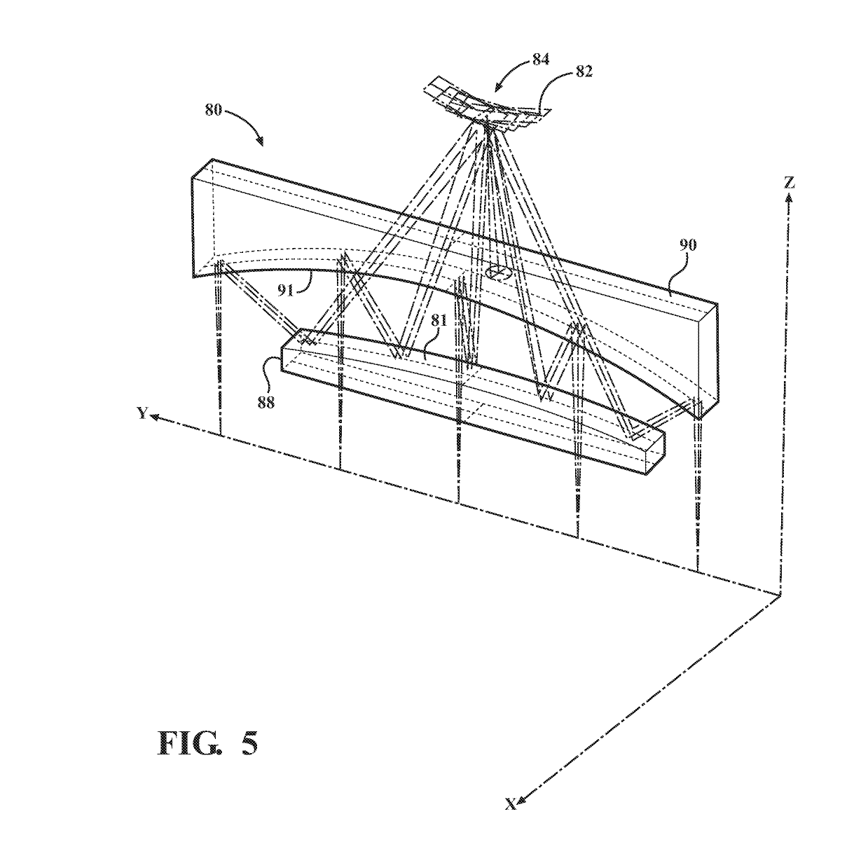

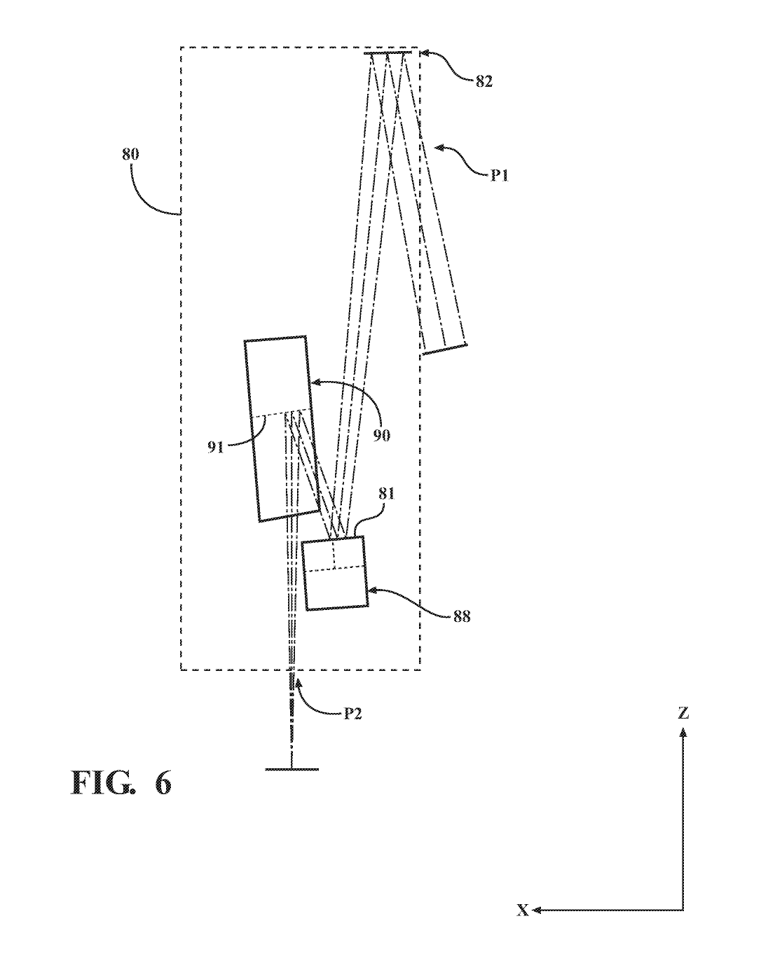

A depiction of the internal components of linear scanning device 80 is provided in FIG. 5. Rotating polygonal mirror 82 rotates about rotational axis 84 and receives laser light from input port P1 (FIG. 6). The incoming light is deflected from one of the facets of rotating polygonal mirror 82 and then is directed to an optical system comprising at least a first 88 and second 90 mirror having a first and a second rotationally symmetric curved mirror surface about their optical axis, respectively, whereby at least one of the first and second curved mirror surface has an aspheric shape. A mirror surface having an aspheric shape is rotationally symmetric around an optical axis of the surface, but does not conform to the shape of a sphere.

In the example of FIGS. 5 and 6, the optical system of linear scanning device 80 comprises a two mirror strip f-theta optical system that includes two curved mirrors 88 and 90. The two curved mirrors 88, 90 are optically symmetrical around their optical axis and have an off-axis decentered aperture that may have a rectangular shape. The term “off-axis” means that the optical center is not located in the middle of the deflecting surface and may be located outside the deflecting surface. As shown in FIG. 6, the mirrors 88, 90 are offset from one another along the build (z) axis. The locations of light impingement on each mirror 88, 90 are also offset from one another along the travel (x) axis. Mirror 88 has an upward facing, convex upper surface 81, and mirror 90 has a downward-facing, concave lower surface 91. As indicated in FIGS. 5 and 6, light deflected from rotating polygonal mirror 82 impinges on the upper convex surface 81 of lower mirror 88 and is deflected toward the downward-facing, lower concave surface 91 of mirror 90 and out through output port P2 (which is a linear opening in the bottom of the housing of linear scanning device 80) onto the solidifiable material. Preferably, a beam expander is provided (not shown) between the laser input port P1 and the rotating polygonal mirror 82. The purpose of the beam expander is to alter the diameter of the beam at input port P1 which ultimately determines the spot diameter at the focal plane 58. One advantage of using mirrors 88, 90 instead of lenses is that the optical system is achromatic and parfocal, i.e., the scanning performance does not depend on the wavelength, and the focal plane is at the same location for all wavelengths. The use of the optical system of FIGS. 6 and 7 provides a fully telecentric linear scanner, which ensures that the angle of incidence of laser light on the solidifiable material does not vary with scanning (y) axis position. A suitable commercial device usable as the linear scanning device 80 is the LSE 170 or LSE 300 supplied by Next Scan Technology of Belgium.

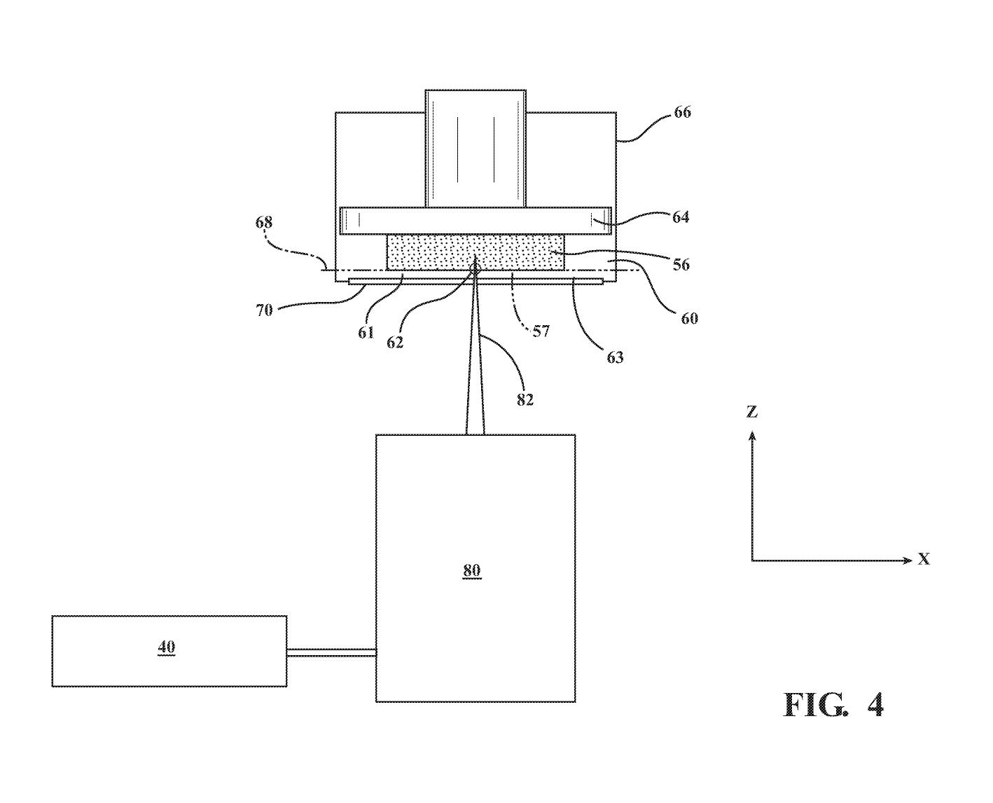

The linear scanning device 80 of FIG. 3 may also be used in an “upside down” build system as shown in FIG. 4. Again, laser 40 may remain stationary or may travel with linear scanning device 80 along the travel (x) axis. The solidifiable material container 66 is configured as described previously. As linear scanning device 80 translates along the travel (x) axis, it scans solidification energy along the scanning (y) axis in patterns dictated by object data representative of the three-dimensional object 56 being built. The focal point 62, and hence the focal plane 58 are spaced apart from the bottom 70 of container 66 and the exposed surface 63 of the solidifiable material located at the bottom 70, thereby creating a non-solidification zone like non-solidification zone 61 in FIG. 1B. Thus, object 56 does not solidify in contact with the glass 70 and need not be separated therefrom following the solidification of each layer. The same types of object data may be used to toggle the energization state of laser 40.

In all of the examples herein, a host computer provides object data to one or more controllers and/or microcontrollers that adjust the energization state of the laser 40, the translation of the movable assembly 48, 72 or linear scanning device 80 and the movement of the build platform 54, 64 along the build (z) axis. Also, in each example, a suitable translation assembly is provided to allow for the translation of the build platform 54, 64 along the build (z) axis and to allow for the translation of the movable assemblies 48, 72 and linear scanning device 80 along the travel (x) axis. Suitable translation assemblies may include motor-driven, pulley type assemblies of the type shown in U.S. Pat. No. 9,079,355 and allow the movable assemblies 48, 72 and scanning device 80 to travel smoothly along the travel (x) axis without allowing any movement along the scanning (y) axis or the build (z) axis. Thus, in each example, linear scan lines are formed along the scanning (y) axis as the movable assembly 48, 72 or linear scanning device 80 moves along the travel (x) axis.

Methods of using the apparatuses of FIGS. 1-7 will now be described. In accordance with a first method, the apparatus of FIGS. 1A and 1B is provided. The x-y planar area where solidification energy may be received is referred to as the “build envelope.” The build platform 54 descends so that the distance from the exposed object surface 57 to the exposed solidifiable material surface 63 is equal to the sum of the build (z) axis height of non-solidification zone 61 and layer thickness Δz of solidifiable material that will be solidified to form the next object layer as shown in FIG. 1B. The movable assembly 48 travels along the travel (x) axis, and the laser 40 is toggled on and off based on object data representative of object 56. When laser 40 is toggled ON, optical fiber beam splitter 44 produces two beams each having half the intensity of laser 40. The rotating polygonal mirrors in linear scanning devices 50a and 50b are rotated in a coordinated manner so that their deflected beams 51a and 51b intersect at a focal point 62 that moves along the scanning (y) axis when laser 40 is toggled to an ON energization state. Focal point 62 is preferably spaced apart from the exposed solidifiable material surface 63 along the build (z) axis by about 0.2 to about 0.5 mm and more preferably from about 0.3 mm to about 0.4 mm. Within non-solidification zone 61, the energy of the individual and uncombined beams 51a and 51b is insufficient to excite the photoinitiators in the solidifiable material to cause polymerization or cross-linking to occur. However, at focal point 62, the intensity doubles, two photon absorption occurs, and polymerization and crosslinking occur within a small volume that extends to the depth of the layer thickness Δz. The design of the various lenses (FIG. 7) in each linear scanning device 50a and 50b and the angular orientation of the linear scanning devices 50a and 50b relative to the build (z) axis determine the distance of the non-solidification zone 61 from the exposed surface 63 of the solidifiable material. After each layer is completed, the build platform 54 descends by a layer thickness Δz and the process repeats. Unlike many known processes for making a three-dimensional object from a solidifiable material, “deep dipping” is not required.

The apparatus of FIG. 2 is used similarly to that of FIGS. 1A and 1B. The build platform 64 is elevated by a distance along the build (z) axis which allows an amount of solidifiable material 60 to enter between the object 56 and the bottom 70 of the container. Following the elevation, the exposed object surface 57 is spaced apart from the exposed solidifiable material surface 63 by a distance along the build (z) axis which equals the desired non-solidification zone 61 distance plus the desired layer thickness Δz of the object to be formed. The movable assembly 72 begins traveling in along the travel (x) axis and the energization state of the laser 40 is toggled ON or OFF based on object data representative of object 56. The rotating polygonal mirrors 124 (FIG. 7) in linear scanning devices 76a and 76b are rotated in a coordinated manner so that when laser 40 is ON, the deflected beams 75a and 75b intersect at focal point 62. Between the exposed resin surface 63 and the focal point 62, no two photon absorption occurs and the energy from the individual beams 75a and 75b is insufficient to excite the photoinitiators and cause polymerization or crosslinking to occur. However, at the focal point 62, two photon absorption occurs, and polymerization/crosslinking occur within a volume that extends to a height Δz from focal point 62 along the build (z) axis, thereby solidifying a region of solidifiable material having a build axis (z) dimension of Δz. Because of the non-solidification zone 61, the newly formed object does not adhere to glass 70 and need not be separated therefrom. The build platform 64 then ascends by the layer thickness Δz, and the process is repeated. The design of the lenses in the linear scanning devices 76a and 76b, the angular orientation of the linear scanning devices 76a and 76b relative to build (z) axis, and the x-axis spacing between the upper surfaces of linear scanning devices 76a and 76b (where the light exist) determine the distance of the non-solidification zone 61 along the build (z) axis.

A method of using the apparatus of FIG. 3 will now be described. In accordance with the method, the build platform 54 is lowered so that the exposed object surface 57 is spaced apart from the exposed resin surface 63 by the sum of the build (z) axis height of the non-solidification zone 61 and a layer thickness Δz. Laser 40 may remain stationary or may travel with linear scanning device 80 along to travel (x) axis. In one example, laser 40 and linear scanning device 80 are contained in a common housing and travel together along the travel (x) axis. Whether or not the laser 40 travels with it, the linear scanning device 80 travels along the travel (x) axis as the energization state of the laser 40 is toggled ON and OFF in accordance with object data representative of object 56. The F-theta mirrors 88, 90 (FIGS. 5 and 6) are designed and positioned so that the focal point 62 is located at a desired distance from the exposed resin surface 63 which defines the non-solidification zone 61 height along the build (z) axis. Between the exposed resin surface 63 and the focal point 62 (i.e., in non-solidification zone 61), two photon absorption does not occur and the energy of the unfocused beam 87 is insufficient to excite the photoinitiators sufficiently to cause polymerization and/or cross-linking. However, at the focal point 62, two photon absorption occurs, and a volume of solidifiable material solidifies to a depth equal to the layer thickness Δz. Because of the non-solidification zone 61, the newly solidified object is not adhered to the glass 70 and need not be separated therefrom. The build platform 54 then descends by a layer thickness Δz, and the process repeats.

A method of using the apparatus of FIG. 4 will now be described. The build platform 64 is elevated so that the exposed object surface 57 is spaced apart from the container bottom 70 by a distance equal to the distance of the non-solidification zone plus a layer thickness Δz. The linear scanning device 80 travels along the travel (x) axis, and the energization state of the laser 40 is toggled ON or OFF based on object data representative of object 56. Laser 40 may remain stationary or may travel along the travel (x) axis with linear scanning device 80. The rotating polygonal mirror 82 deflects received laser energy to mirrors 88 and 90, which then deflect beam 87 into solidifiable material 60. The mirrors 88 and 90 are positioned and designed so that focal point 62 is positioned above the exposed surface 63 of solidifiable material 60 by a distance equal to the non-solidification zone 61 height along the build (z) axis. Between the exposed surface 57 of solidifiable material 60 and the focal point 62, no two-photon absorption occurs and the energy of beam 87 is insufficient to excite the photoinitiators sufficiently to cause polymerization and/or crosslinking. However, at focal point 62, two photon absorption occurs, and the solidifiable material solidifies to a depth equal to the layer thickness Δz. Because of the non-solidification zone, the newly formed object section does not adhere to the container bottom 70 and need not be separated therefrom. The build platform 64 is then elevated by a layer thickness Δz, and the process repeats.

In each of the examples described herein, the build platform 54, 64 may pause in its movement along the build (z) axis during the periods when solidification energy is being applied to the solidifiable material 60 or it may continue to move during those periods (i.e., “continuous build” processes may be used). The systems described herein are particularly well suited for continuous build processes because the obviate they need for separating a solidified object section from a solidification substrate (e.g., glass 70) after a section of the three-dimensional object is formed.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. An apparatus for making a three-dimensional object from a solidifiable material, comprising:
a selectively activatable laser having a first wavelength;
a linear scanning assembly comprising two linear scanning devices;
an optical fiber beam splitter having an input and two outputs, wherein each output is connected to a respective one of the linear scanning devices, wherein the linear scanning devices are movable along a travel axis and each scan along a scanning axis a respective beam of solidification energy received from a corresponding one of the optical fiber splitter outputs;
a source of solidifiable material having an exposed surface;
wherein the linear scanning devices are configured such that their respective beams intersect at a focal point within the solidifiable material that is spaced apart from the exposed surface along a build axis.

2. The apparatus of claim 1, wherein the focal point is spaced apart from the exposed surface of the solidifiable material by a distance that is no less than about 0.2 mm from the exposed surface of the solidifiable material.

3. The apparatus of claim 1, wherein the selectively activatable laser has a pulse width of less than about 10⁻⁸ seconds.

4. The apparatus of claim 1, wherein the selectively activatable laser has a wavelength between about 700 nm and about 800 nm.

5. The apparatus of claim 1, wherein the laser power at the focal point is at least about 1 GW.

6. The apparatus of claim 1, wherein the selectively activatable laser has an average output power of at least about 150 mW.

7. The apparatus of claim 1, wherein the solidifiable material comprises a multiphoton sensitizer.

8. The apparatus of claim 1, wherein the solidifiable material comprises a photoinitiator having an excitation wavelength range that includes one half of the first wavelength.

9. The apparatus of claim 1, wherein when the input of the optical fiber beam splitter receives laser light of the first wavelength, the two outputs each transmit light having second wavelengths that are substantially equal.

10. The apparatus of claim 1, wherein when the input of the optical fiber beam splitter receives laser light of a first intensity, the two outputs each transmit light having a second intensity that is about one half of the first intensity.

11. The apparatus of claim 1, wherein the linear scanning devices are configured such that their respective beams intersect to define a spot having a diameter of no more than about 20 microns at the focal point.

12. The apparatus of claim 1, wherein the selectively activatable laser is a Ti:Sapphire laser.

13. The apparatus of claim 1, wherein the power of each respective beam is insufficient to solidify the solidifiable material between the focal point and the exposed surface of the solidifiable material.

14. The apparatus of claim 1, wherein the linear solidification devices are spaced apart from and located above the source of the solidifiable material along the build axis.

15. The apparatus of claim 1, wherein the linear solidification devices are spaced apart from and located beneath the source of the solidifiable material along the build axis.

16. The apparatus of claim 1, wherein multi-photon-induced polymerization occurs at the focal point.

17. The apparatus of claim 1, wherein the solidifiable material comprises a photoinitiator, and the photoinitiator absorbs the energy of two photons at the focal point.

18. An apparatus for making a three-dimensional object on a build platform by solidifying a solidifiable material contained in a source of solidifiable material, the apparatus comprising:
a selectively activatable laser configured to selectively transmit laser light of a first wavelength;
a linear scanning device comprising a rotatable polygonal mirror and an optical system, wherein the selectively activatable laser is in optical communication with the rotating polygonal mirror, the linear scanning device travels along a travel axis, and the optical system comprises at least one first mirror and second mirror between the rotating polygonal mirror and an exposed surface of the solidifiable material, the at least one first mirror and second mirror have a rotationally symmetric curved mirror surface about their optical axis, at least one of the first and the second curved mirror surface has an aspheric shape, and the at least one first and second mirror have an off-axis decentered aperture and are offset in position with respect to one another in a direction perpendicular to a scanning axis,
wherein the exposed surface of the solidifiable material is located between the linear scanning device and the build platform, when the selectively activatable laser is activated while the rotatable polygonal mirror rotates, laser light is deflected from the rotatable polygonal mirror through the optical system to scan a focal point of solidification energy within the solidifiable material and along the scanning axis, the focal point is spaced apart from the exposed surface of the solidifiable material along a build axis, the solidifiable material solidifies at the focal point and does not solidify between the exposed surface of the solidifiable material and the focal point.

19. The apparatus of claim 18, wherein the laser is stationary as the linear scanning device travels along the travel axis.

20. The apparatus of claim 18, wherein the laser travels along the travel axis as the linear scanning device travels along the travel axis.

21. The apparatus of claim 18, wherein the laser has a pulse width of less than about 10⁻⁸ seconds.

22. The apparatus of claim 18, wherein the selectively activatable laser has a wavelength between about 700 nm and about 800 nm.

23. The apparatus of claim 18, wherein the laser power at the focal point is at least about 1 GW.

24. The apparatus of claim 18, wherein the selectively activatable laser has an average output power of at least about 150 mW.

25. The apparatus of claim 18, wherein the solidifiable material comprises a multiphoton sensitizer.

26. The apparatus of claim 18, wherein the solidifiable material comprises a photoinitiator having an excitation wavelength range that includes half of the first wavelength.

27. The apparatus of claim 18, wherein when the selectively activatable laser is activated, the focal point has a spot diameter of no more than about 20 microns.

28. The apparatus of claim 18, wherein the selectively activatable laser is a Ti:Sapphire laser.

29. The apparatus of claim 18, wherein the linear scanning device is spaced apart from and located above the source of the solidifiable material along the build axis.

30. The apparatus of claim 18, wherein the linear scanning device is spaced apart from and located beneath the source of the solidifiable material along the build axis.

31. The apparatus of claim 18, wherein multi-photon-induced polymerization occurs at the focal point.

32. The apparatus of claim 18, wherein the solidifiable material comprises a photoinitiator, and the photoinitiator absorbs the energy of two photons at the focal point.

33. The apparatus of claim 18, wherein the shape of the first and second mirror is optimized for telecentricity less than 5 degrees and line bow less than +20/−20 microns for mechanical scan angles of +/−16 degrees, and a spot size variation less than 5%.

34. The apparatus of claim 18, wherein the other one of the at least one first and second curved mirror surface has a spherical shape.

35. The apparatus of claim 18, wherein the other one of the at least one first and second curved mirror surface also has an aspheric shape.

36. The apparatus of claim 18, wherein the optical system consists of the first mirror and the second mirror.

37. An apparatus for making a three-dimensional object from a solidifiable material, comprising:
a solidifiable material container containing the solidifiable material such that the solidifiable material has an exposed surface;
a selectively activatable laser;
a linear scanning device operatively connected to the laser, wherein the linear scanning device is movable along a travel axis and scans solidification energy received from the laser in linear patterns along a scanning axis, and the linear patterns have a focal point spaced apart from the exposed surface of the solidifiable material along a build axis.

38. The apparatus of claim 37, wherein the laser is a femtosecond laser.

39. The apparatus of claim 37, wherein the linear scanning device comprises a rotatable polygonal mirror configured such that when the linear scanning device moves along the travel axis, the rotating polygonal mirror rotates in a plane perpendicular to the travel axis and parallel to the scanning axis.

40. The apparatus of claim 37, wherein the solidifiable material comprises a photoinitiator that is capable of simultaneously absorbing two photons of energy at the focal point but not between the focal point and the exposed surface of the solidifiable material.

41. A method of making a three-dimensional object from a solidifiable material, comprising:
providing a source of the solidifiable material, wherein the solidifiable material comprises a photoinitiator;
selectively activating a laser in optical communication with a rotating polygonal mirror as the rotating polygonal mirror travels along a travel axis to scan laser energy in a linear pattern along a scanning axis within the solidifiable material such that the photoinitiator absorbs two photons at a selected distance from an exposed surface of the solidifiable material along a build axis, wherein the solidifiable material solidifies at the selected distance but does not solidify between the selected distance from the exposed surface of the solidifiable material and the exposed surface of the solidifiable material.

42. The method of claim 41, further comprising providing a linear scanning device comprising the rotating polygonal mirror and an optical system comprising at least one first mirror and second mirror between the rotating polygonal mirror and the exposed surface of the solidifiable material, the at least one first mirror and second mirror each having a rotationally symmetric curved mirror surface about their optical axis, at least one of the first and the second curved mirror surfaces having an aspheric shape, and wherein the first and the second mirror have an off-axis decentered aperture and are offset in position with respect to one another in a direction perpendicular to the scanning axis.

43. The method of claim 41, wherein the laser has a pulse width of less than 10⁻⁸ seconds.

44. The method of claim 41, wherein the selectively activatable laser has a wavelength between about 700 nm and about 800 nm.

45. The method of claim 41, wherein the selectively activatable laser is connected to an optical fiber splitter having two outputs, each output is connected to a corresponding linear scanning device, one of the linear scanning devices comprises the rotating polygonal mirror, and the other of the linear scanning devices comprises another rotating polygonal mirror, and when the laser transmits laser energy to the linear scanning devices they each deflect a beam of laser energy, and the deflected beams of laser energy intersect at the selected distance from the exposed surface of the solidifiable material.
